(19) United States
(12) Patent Application Publication
(10) Pub. No.: US 2008/0133774 A1
(43) Pub. Date: Jun. 5, 2008

(54) METHOD FOR IMPLEMENTING TRANSPARENT GATEWAY OR PROXY IN A NETWORK

(76) Inventor: Jai-hyoung Rhee, Seoul (KR)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/838,667

(22) Filed: Aug. 14, 2007

Related U.S. Application Data
(63) Continuation of application No. 10/362,650, filed on Aug. 8, 2003, now abandoned.

(30) Foreign Application Priority Data
Jun. 22, 2001 (KR) 2001-0035710

(51) Int. Cl. G06F 15/16

(52) U.S. Cl. 709/246

(57) ABSTRACT

This invention relates to a method for implementing transparent gateway or proxy in a network, more specifically is characterized in using NAT transformation method in network devices adapting network address transformation method, such as router, gateway and/or switching device. According to the present invention, Client and server can communicate with each other without recognizing gateway though gateway is provided on the network path.

### CROSS-REFERENCE TO RELATED APPLICATIONS

This application is a continuation of application Ser. No. 10/362,650, filed Aug. 8, 2003, which is hereby incorporated by reference in its entirety. Application Ser. No. 10/362,650 is the National Stage application filed under 35 U.S.C. §371 of PCT Application No. PCT/KR02/00600, filed Apr. 4, 2002, which claims foreign priority benefits under 35 U.S.C. § 119(a)-(d) or §365(b) of Korean Application No. 2001-0035710, filed Jun. 22, 2001, each of which is hereby incorporated by reference in their entirety.

### TECHNICAL FIELD

The present invention relates to a method for implementing transparent gateway or transparent proxy on a network, in particular, to a method for implementing transparent gateway or transparent proxy by using modified network address translation (hereinafter, “NAT”) method on a router, a gateway or a switching device, etc., which are implementing NAT method.

### BACKGROUND ART

A transparent gateway allows a user to seem to communicate with a communication partner without the gateway. In other words, a transparent gateway enables a user to perform additional works by transmitting all packets corresponding to a TCP service port to the gateway or proxy without setting the gateway or proxy.

Generally, a proxy or gateway of an intrusion cut off system is most frequently used as a gateway. In a proxy, a user usually sets up or accesses to a proxy, and then, accesses further to a real server. However, in a transparent gateway, if a user accesses directly to a desired system without acknowledging the existence of a gateway or proxy, the transparent gateway establishes a connection to the real server after completion of a confirmation procedure. Accordingly, the user and the server might believe that they were communicating directly with the partner without a gateway.

Current technology allows constitution of a system of transparent proxy for a web proxy. Here, if a TCP packet having a designated web service port is re-directed to the proxy on a network device, the proxy reads all packets and communicates to re-connect to the server by using its own Internet Protocol (hereinafter, “IP”). The above process is implemented by using the HTTP protocol having the host name and URL of the partner web server to be connected to.

Although this method is meaningful in that a user is allowed to directly connect to the server without a designated proxy, a problem arises here, that the server acknowledges not the original client but the proxy to be its client. This constitution is problematic not only in case that the server has difficulty in acknowledging the correct client, but also in case that it includes a vital disadvantage for adoption of an IP based authentication system. Furthermore, since the server can hardly acknowledge the correct user, it is possible that services cannot be provided to those accessed through the gateway, unless the problem of dues has been solved. Accordingly, enterprises or organizations that have adopted the gateway for security or other purposes may confront the following troubles in connection with operation of the gateway.

First, an additional work for changing the user environment is required. Second, a burdensome process of educating the users for correct use of the gateway will be obligatory. Third, an additional cost incurs for operating help-desks for the parts that are likely to cause problems in use practice by the users. Fourth, even though a transparent web proxy as described above is operated, control servers among numerous systems on the Internet based on IP cannot receive proper services. Fifth, since a transparent web proxy is applicable only to webs capable of acknowledging the destination server existing in an application protocol such as HTTP, a user first accesses to a gateway, and then, to a server IP from the gateway in order to establish a connection, if the gateway is constituted as a gateway such as Telnet or FTP. Accordingly, implementation of a transparent proxy or transparent gateway is necessary not only for a transparent proxy, but also for application programs about all services based on TCP.

The structure of the Internet, which has experienced rapid growth during recent years, was first created several decades ago when a current huge amount of connections are unpredictable. The concept of NAT has been introduced to solve a problem of an available IP. The NAT, being a concept based on reuse of private network addresses, is applied, in general, to a router and the like in a manner that the router receives data from each ports, converts the source IP address field of an IP packet in accordance with the NAT rule (Mapping Rule) into an authorized IP address, and then, transmits the same.

A network device applied to the above NAT stores an appropriate amount of authorized IP addresses in a separate address pool, and allocates those addresses among the authorized IP addresses that are not used, to the private network, if the private network requests the external network for an accession. Here, translation of the authorized IP address is administered by a NAT table.

FIG. 1 is a conceptual diagram for a general description of the basic NAT. As shown in FIG. 1, in case of an outgoing data flow in the basic NAT, a global address is allocated to the source local IP address and then recorded in the NAT table, the local IP address is translated into a global IP address, and then, transmitted. While in case of an incoming data flow, a local IP address is searched using the global IP address of the destination i.e. the translated source in the above outgoing case, and then, the global IP address is translated into a local IP address. Since the packets are classified by the IP addresses in such basic NAT, multiple hosts do not share same global IP address. Although a conversion of addresses is performed easily in such basic NAT, the use rate of an global IP address is drastically reduced. A more detailed explanation is given below with reference to FIG. 1.

For example, assuming that host A of the local network communicates with host X of the global network, while host B of the local network communicates with host Y of the global network, the source A's address as well as the global IP address G allocated thereto are recorded in the NAT table for the data flow from A to X. Further, if the same IP address allocated to the data flow from A to X (G) is also allocated to the data flow from B to Y as illustrated in FIG. 1, the local addresses of both A and B are searched so that a confusion arises as to where transmit the data when the NAT table is searched only by the destination address G for transmission of the data from Y in case of incoming in the basic NAT. Accordingly, a plurality of hosts having separate IP addresses in the local network cannot be translated into one and the same global IP simultaneously in the basic NAT. In order to solve this problem, an NAT table is commonly used to keep records on the IP, the ports, etc.

Further in FIG. 1, for the data flow from A to X, the source A's address and the port number 100 as well as the allocated global IP address G and the port number 1000 are recorded in the NAT table. Also for the data flow from B to Y, a global address G with a varied port number 2000 can be allocated to the source B's address and the port number 100. In case of an incoming data flow, if the NAT table is searched with the destination address G and the port number 2000 for the purpose of transmitting the data transmitted from Y to B, only B's local address and the port number 100 are searched, thus the data flow from A to X can be separated from the data flow from B to Y.

### SUMMARY OF THE INVENTION

To solve the above problems, an object of the present invention to provide a method for implementing transparent gateway or transparent proxy by using modified network address translation (hereinafter, “NAT”) method on a router, a gateway or a switching device, etc., which are implementing NAT method.

To solve the above problems, an object of the present invention to provide a method for implementing a transparent gateway or a transparent proxy in a network including at least one gateway or at least one proxy, by using a network device including a NAT table, comprising a first step of confirming whether a source or a destination port of a received packet exists in said NAT table; a second step of confirming whether a source IP of the packet is the same as the gateway IP if said source or destination port has been confirmed in said first step to be existent in said NAT table; and a third step of translating the source IP or a destination IP of said packet, depending on whether or not the source IP of the packet is same as the gateway IP, if the above second step occurs, wherein said third step further comprising; (i) if the source IP of said packet turns out to be not the same as the gateway IP as a result of the above second step, a step that a session is registered in a session information table if a SYN flag has been set in said packet; a step that said session is searched in the session information table if a preset gateway mode is a general gateway mode, and the destination IP of said packet is changed to the gateway IP when said session search yields any result; and a step that said packet is directly transmitted if the preset gateway mode is a transparent gateway mode, and (ii) if the source IP of said packet turns out to be the same as the gateway IP as a result of the above second step, a step that the session is searched in the session information table; and if said session search yields any result, a step that the source IP is changed from the gateway IP to a real source IP after deleting the session from the session information table if a FIN or RST flag is set in said packet.

### BRIEF DESCRIPTION OF THE DRAWINGS

FIG. 1 is a conceptual diagram showing the basic NAT technology.

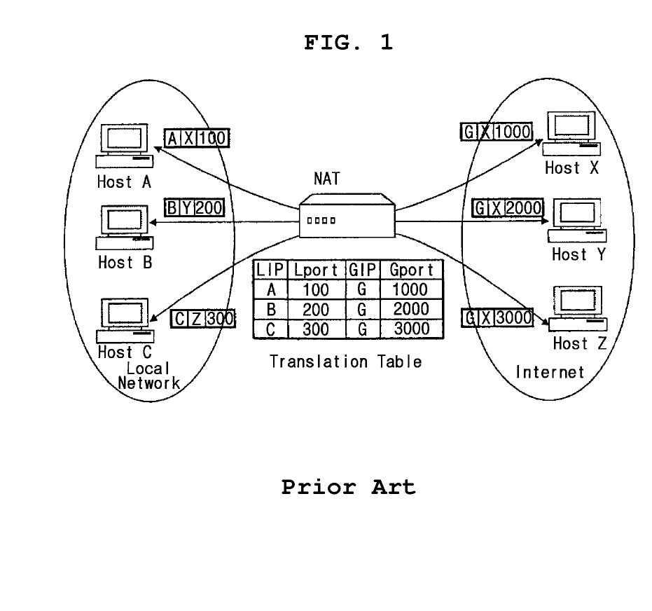

FIG. 2 is a diagram showing a constitution of an IP header.

FIG. 3 is a diagram showing a constitution of a TCP header.

FIG. 4 is a diagram showing a network constitution that a transparent gateway according to the present invention is applied.

FIG. 5 is a conceptual diagram showing a varied NAT technology.

FIG. 6 is a flow chart of an example of TCP session connection process to a general gateway in accordance with the present invention.

FIG. 7 is a flow chart of an example of TCP session connection process of a gateway as set by a transparent proxy in accordance with the present invention.

FIG. 8 is a flow chart of a varied NAT method in accordance with the present invention.

### PREFERRED EMBODIMENTS OF THE INVENTION

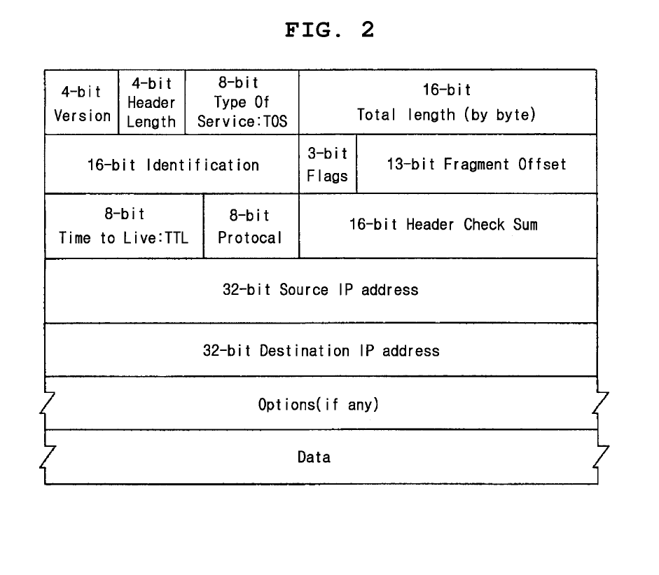

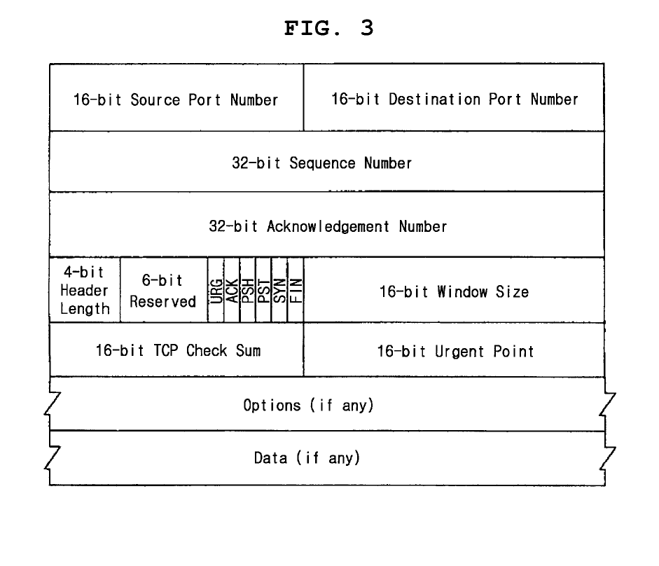

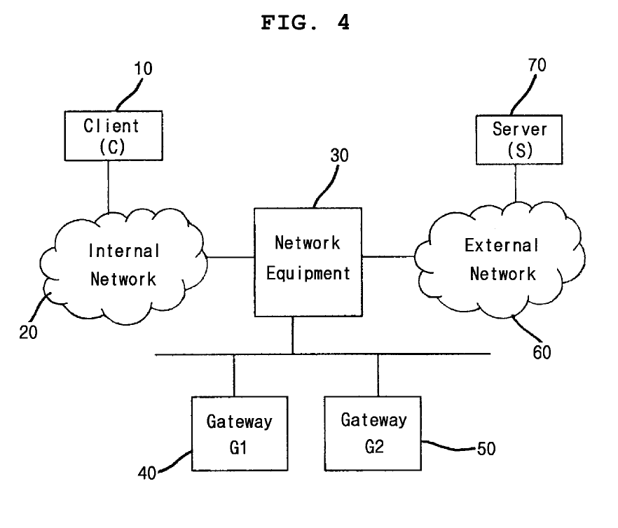

The preferred embodiments of the present invention are described below in detail with reference to drawings. FIG. 2 is a diagram showing a constitution of an IP header; FIG. 3 is a diagram showing a constitution of a TCP header; and FIG. 4 is a diagram showing a network constitution that a transparent gateway according to the present invention is applied.

In FIG. 4, a client 10 can directly communicate with a server 70. However, generally a gateway is installed between networks for security or other purposes. A typical example of such gateway is an intrusion cut off system. Various other gateways such as web proxy, SMTP gateway, FTP gateway, Telnet gateway, and etc. can be also considered. When a gateway is installed on a traffic path of a network, the clients commonly have to access the gateway by changing the environment. Then, the gateway accesses to the server again when the clients communicate with the server via an IP data program. Accordingly, the IP header can be changed in the IP data program of a network device 30 including a NAT. If an outgoing packet is required to transmitted to a gateway, the destination IP of the packet is changed so that a gateway receives the packet. Then the packet is transmitted to gateway G1 40 or G2 50, and the transmitted packet is read and processed by the gateway G1 40 or G2 50. After the processing is completed, the packet is transmitted back to the network device 30, whereupon the network device 30 changes the source IP of the packet from the gateway IP to the client IP, and then, transmits the same to the server 70.

Now, an explanation on the incoming packet from the server 70 follows. Upon receiving the incoming packet, the network device 30 changes the destination IP from the client IP to the gateway 40, 50 IP. After processing by the gateway 40, 50, the packet is transmitted back to the network device 30, and then, transmitted to the client 10 after the packet's source IP has been changed to the server 70 IP. As such, a communication is performed between the client 10 and the server 70 while the gateway IP remains hidden.

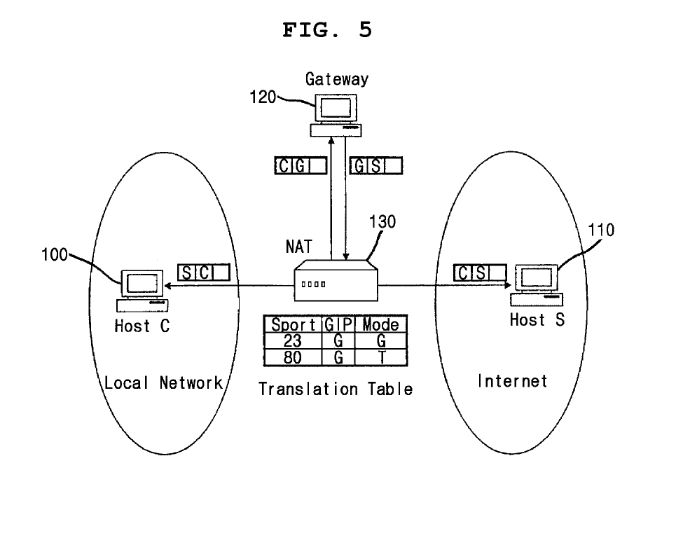

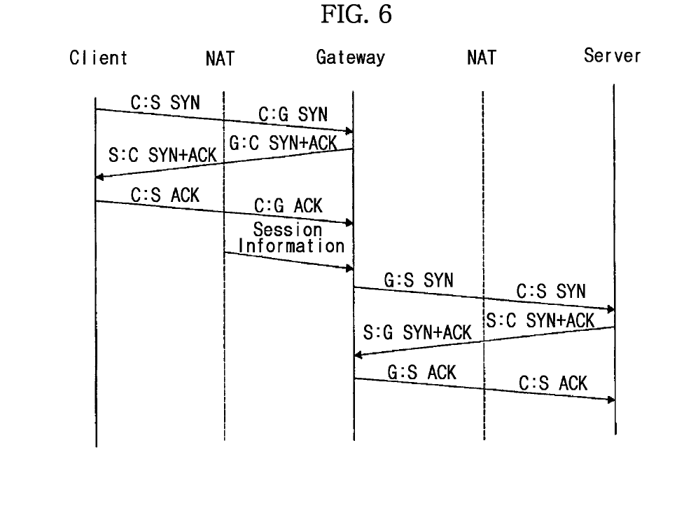

An explanation of examples of the method for implementing a transparent gateway or a transparent proxy in accordance with the present invention is given below, with reference to FIGS. 5 and 6.

FIG. 5 shows a constitution illustrating an embodiment example of the method for implementing a transparent gateway or a transparent proxy in accordance with the present invention using a varied NAT technology, while FIG. 6 is a flow chart of an example of TCP session connection process to a general gateway in accordance with the present invention.

In FIG. 5, host C 100 is a client of which the IP address is C, while host S 110 is a server of which the IP address is S. Now, the NAT table of the network device 130 defines as illustrated in the drawing. That is, the destination port of the Telnet using port no. 23 is 23, while using the gateway G, and the destination port of the web using port no. 80 is 80, while using the gateway G.

As shown in FIGS. 5 and 6, host C 100 attempts to establish a communication connection with host S 110. In the course of this procedure, SYN flag is set to TCP packet (C:S, 23 SYN). The TCP header includes the source port as well as the destination port. The NAT 130 of the network device recognizes that the packets of which the destination port is 23 or 80 shall be transmitted. Subsequently, the packet is routed to the gateway 120 after a destination IP of the packet is changed to G. The network device 130 registers routing information in the session information table. The session information table is configured as below.

| | Client Port | | | Gateway | |
|---|---|---|---|---|---|
| Client IP | Mode | Server IP | Server Port | IP | Mode |
| C | 1024 | S | 23 | G | G |

After receiving the packet, the gateway 120 transmits the packet as it is set with SYN and ACK flags through the network device 130 to the client 100 (G, 23:C SYN+ACK). The network device 130, then, determines how to process the packet, with reference to the session information table. Since the source port is 23, it can be known that this packet is a response packet to the client. Accordingly, the packet is transmitted to the client after its source IP has been changed to the server IP.

Then, the client 100 transmits the packet containing an ACK flag (C:S, 23 ACK) further. Herewith, a TCP connection between the client and the gateway is established. A problem regarding the above procedure is, however, that the real destination IP is not known to the gateway. Thus, the NAT of the network device 130 has to transmit value of the above table back to the gateway 120. As shown in FIG. 6, the network device 130 including the NAT transmits the session information to the gateway 120. Accordingly, the gateway 120 recognizes the real server IP to be connected.

Next, the gateway 120 transmits the packet including a SYN flag (G:S, 23 SYN) in order to connect to the server by a TCP. The gateway IP as a source IP is changed to the packets which is changed to C (G;S, 23 SYN) as the client IP and is transmitted to the gateway with reference to the above table in the network device 130. The server 110 transmits the response packet (S, 23:C SYN+ACK) to the client 100. Here, since the network device 130 first reads and processes the packet, it can be known that the gateway 120 is used in accordance with the value of the above session information. Accordingly, the packet is transmitted to the gateway 120 after its destination IP is changed from client C to gateway (G S, 23:G SYN+ACK).

If the gateway 120 transmits a packet set with an ACK flag (G:S, 23 ACK) back to the server 110, the network device 130 transmits a packet corrected by the client information obtained from the value of the session information table (C:S, 23 ACK) to the server 120. Herewith a TCP connection between the gateway 100 and the server 110 is established. In this way, the real client 100 is TCP connected to the server 110 via the gateway 120.

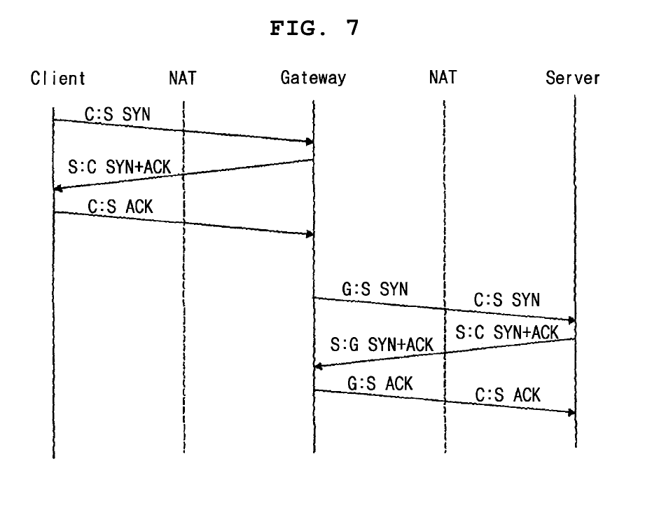

FIG. 7 is a flow chart of an example of TCP session connection process of a gateway as set by a transparent proxy in accordance with the present invention.

Several general commercial gateways or proxies are capable of recognizing location of the destination, dependent on their application programs, of which the typical examples are relay mail system and web proxy HTTP. In such case, the destination IP is searched within the data of the application programs. However, in this case, since the protocol of the application program is changed when the session information is transmitted to the gateway as in FIG. 6, a problem arises that the commercial program cannot be used as it is provided. For solving this problem, a mode column is provided for in the NAT table in FIG. 5. Here the mode value G, means that it is a general gateway, while the mode value T means that the gateway is a transparent gateway, which can recognize the destination IP.

If the destination port is set to as 80 and the web proxy is set to be the gateway, the mode is set to T and a TCP connection as in FIG. 7 can be established. However, FIG. 7 differs from FIG. 6 in that the session information is not transmitted to the gateway.

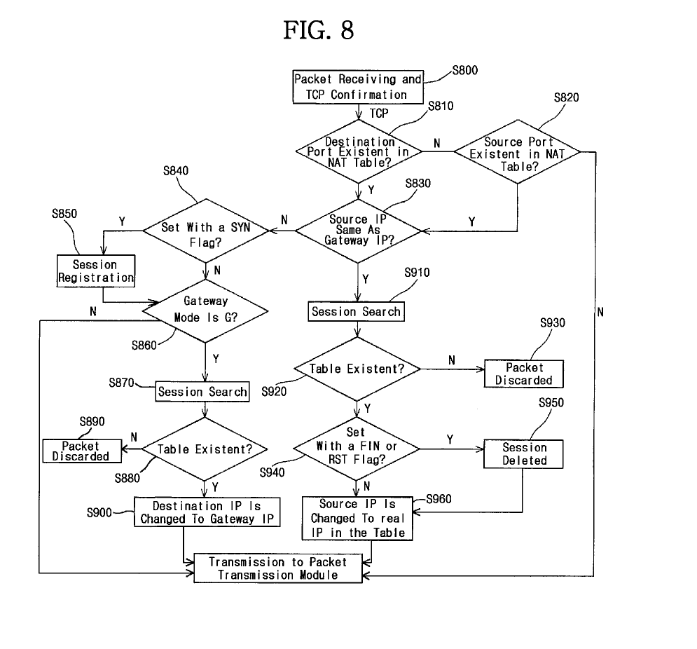

FIG. 8 is a flow chart of a varied NAT method according to the present invention.

Upon receiving a packet, it is confirmed whether the packet is a TCP or not S800. The packet is immediately transmitted in case it is not a TCP. In case the packet is a TCP, it is confirmed whether the destination port is in the NAT table S810. If the destination port is not in the NAT table, it is further confirmed whether the source port is in the NAT table S820. If the source port is not in the NAT table, which means that the packet is irrelevant to the gateway, it is transmitted directly to the packet transmission module.

In case the source port or destination port is existent in the NAT table, it is confirmed whether the source IP is a gateway IP S830. As a reference, there can be no instance where a destination IP is a gateway IP, because changing a destination IP to a gateway IP belongs to the function of the NAT.

In case the source IP is not a gateway IP, it means that the packet is a client packet or a server packet. If the packet includes a setting of a SYN flag S840, which initiates a session, the session is registered in the session information table S850.

Subsequently, it is confirmed whether the gateway mode is G S860 or not. If the gateway mode is not the G but the T, the packet is transmitted directly to the packet transmission module without changing the IP address. If the gateway mode is G, a session search in the session information table is performed 870. The search method determines whether the search result exists or not by searching the unique record including information of a source IP, a source port, a destination IP, and a destination port S880.

In a case that the search result exists, the destination IP is changed to a gateway IP S900, and the packet is transmitted to the module. In case the search result does not exist, the packet is discarded S890. The above description relates to cases where the packet has bee received from the client or the server.

In case, however, the gateway processes and transmits the packet S830, the record in the session information table is searched with destination IP, destination port, gateway IP, and source port S910. After the search, it is confirmed whether the table yields any result S920. In case the table yields any result, the session is deleted from the session table S950 if the packet which is set with a FIN flag occurs in twice or if the packet which is set with a RST flag is processed S940, and the source IP is changed from the gateway IP to the real IP in the table S960 and the packet is transmitted to the packet transmission module.

If the packet which is set with a FIN flag does not occur in twice or if the packet which is set with a RST flag has not been processed in the above step S940, the step of deleting the session 950 is omitted, and the packet is transmitted to the packet transmission module after the source IP is changed form the gateway IP to the real IP in the table.

On the other hand, if the session information table does not contain a record in the above step S920, the packet is discarded S930.

Although the constitution and effects of the present invention have been described above referring to the preferred embodiments of the invention, the scope of rights of the present invention is not limited thereto, but rather shall be determined by the appended claims, allowing various adaptations and modifications, without departing the scope and spirit of the present invention as those skilled in the art will understand.

### INDUSTRIAL APPLICABILITY

As described above, the present invention allows a user to communicate with a communication partner through a transparent gateway or a transparent proxy, not noticing the existence thereof, and not requiring any change in the user environment.

Further, the present invention enables a substantial reduction in time and costs in constituting and maintaining a network, by making the obligatory education of the users for use of the gateway unnecessary.

In addition, the present invention allows a control server based on IP to provide with normal services, and ensures transparency even for a proxy or gateway with regard to a protocol, whose destination IP cannot be known from the contents thereof, such as Telnet or FTP.

What is claimed is:

1. A method for implementing a transparent gateway or a transparent proxy in a network including at least one gateway or at least one proxy, by using a network device including a NAT table, comprising:
a first step of confirming whether a source or a destination port of a received packet exists in said NAT table;
a second step of confirming whether a source IP of the packet is the same as a gateway IP in case that said source or destination port has been confirmed in said first step to be existent in said NAT table; and
a third step of translating the source IP or a destination IP of said packet, depending on whether or not the source IP of the packet is same as the gateway IP, when the above second step occurs,
wherein said third step further comprising;
(i) in case that the source IP of said packet turns out to be not the same as the gateway IP as a result of the above second step,
a step that a session is registered in a session information table in case that a SYN flag has been set in said packet;
(ia) a step that said session is searched in the session information table in case that a preset gateway mode is a general gateway mode, and the destination IP of said packet is changed to the gateway IP when said session search yields any result; and
(ib) a step that said packet is directly transmitted in case that the preset gateway mode is a transparent gateway mode, and
(ii) in case that the source IP of said packet turns out to be the same as the gateway IP as a result of the above second step,
a step that the session is searched in the session information table; and
in case that said session search yields any result, a step that the source IP is changed from the gateway IP to a real source IP after deleting the session from the session information table in case that a FIN or RST flag is set in said packet.

2. A method for implementing a transparent gateway or a transparent proxy in a network as set forth in claim 1, wherein said session is searched with the source IP, the source port, the destination IP, and the destination port in case that the source IP is not the same as the gateway IP in the above third step.

3. A method for implementing a transparent gateway or a transparent proxy in a network as set forth in claim 1, wherein said session is searched with the destination IP, the destination port, the gateway IP, and the source port in case that the source IP is the same as the gateway IP in the above third step.
